(19) United States
(12) Patent Application Publication
(10) Pub. No.: US 2012/0200125 A1
(43) Pub. Date: Aug. 9, 2012

(54) PASSENGER SEAT DEVICE

(75) Inventor: Sven Achilles, Michelfeld (DE)

(73) Assignee: RECARO Aircraft Seating GmbH & Co. KG, Schwabisch Hall (DE)

(21) Appl. No.: 13/376,408

(22) PCT Filed: Jun. 11, 2010
(86) PCT No.: PCT/EP2010/003506

§ 371 Date: Apr. 25, 2012

(30) Foreign Application Priority Data
Jun. 12, 2009 (DE) 10 2009 024 702.5

(51) Int. Cl. B64D 11/06; A47C 7/62

(52) U.S. Cl. 297/188.01; 297/233

(57) ABSTRACT

A passenger seat device, in particular an air passenger seat device, including a seat surface unit that is assigned to a first row of seats having a plurality of passenger seats, a comfort unit, which, in addition to the seat surface unit, in at least one usage position forms at least one first support surface that is provided for supporting at least one body part of a reclined passenger.

### CROSS REFERENCE TO RELATED APPLICATIONS

This application is a U.S. national stage application of PCT/EP2010/003506 filed on Jun. 11, 2010, and claims priority to, and incorporates by reference, German patent application No. 10 2009 024 702.5 filed on Jun. 12, 2009.

### BACKGROUND

The invention proceeds from a passenger seat device, in particular an air passenger seat device, having a seat surface unit which is assigned to a first seat row with a plurality of passenger seats.

In the field of transport means, passenger seats are distributed in a known way in seat rows which typically extend transversely with respect to a transport direction. A seat row has a plurality of directly adjacent passenger seats, a seat surface unit in a seat row consisting of individual seat surfaces or being configured as a single contiguous seat surface. If an entire seat row is occupied by a single passenger, the passenger can use the available seat surface unit for lying on in the case of a long haul journey.

The invention is based on the object of providing a passenger seat device of the generic type, in which the passenger comfort can be increased. This object is achieved by the combination of features in patent claim 1, while further advantageous developments of the invention can be gathered from the subclaims.

### SUMMARY

The invention proceeds from a passenger seat device, in particular an air passenger seat device, having a seat surface unit which is assigned to a first seat row with a plurality of passenger seats. A “seat surface” is intended to be understood, in particular, to be a surface which is provided for supporting the bottom of a seated passenger. It differs, in particular, from a backrest surface which serves to support the back of the passenger. In an upright position of a passenger seat, the seat surface is preferably oriented substantially horizontally. A seat surface unit which is “assigned to a seat row” is intended to be understood, in particular, to be the entire seat surface which is available for sitting in the seat row. The seat surface unit has, in particular, a plurality of directly adjacent seat surfaces which are assigned in each case to a different passenger seat of the seat row. It can have seat surfaces which are separate from one another and are formed by separate seat parts of the corresponding passenger seats of the seat row, or it can have seat surfaces which form a contiguous seat surface which extends over the entire seat row, as in the case of the configuration as a seat bench, in particular. A “seat row” is to be understood, in particular, to be a set of a plurality of passenger seats which are directly adjacent to one another in such a way that it is possible for a passenger to lie on the seat surface unit which is formed by the passenger seats. To this end, an intermediate space which is possibly present between two directly adjacent passenger seats in a seat row, in at least one configuration of the seat row, is advantageously free of components which prevent a person lying on the seat surface unit.

It is proposed that the passenger seat device has a comfort unit which, in addition to the seat surface unit, forms at least one first supporting surface in at least one use position, which at least one first supporting surface is provided for supporting at least one body part of a lying passenger. As a result, the comfort of a passenger can be increased, which passenger occupies the seat surface unit which is assigned to the entire seat row for lying. The comfort unit advantageously affords an increase in the surface area which is available for lying. The passenger can support the substantial part of his body on the existing seat surface unit, the additional supporting surface of the comfort unit advantageously serving to support his feet and/or, if he is lying on his side, to support his knees. In one embodiment of the invention, the supporting surface of the comfort unit can be configured in such a way that the passenger can support the substantial part of his body on the supporting surface. “Provided” is to be understood as meaning, in particular, specially configured, equipped or designed.

In one preferred configuration of the invention, it is proposed that the passenger seat device has a seat arrangement with the first seat row and a second seat row, the comfort unit being assigned at least to the second seat row in a storage position. This is to be understood, in particular, as meaning that the second seat row serves to mount at least one component of the comfort unit in its storage position, as a result of which a space-saving embodiment can be achieved.

The seat rows preferably have the same seat direction. The “seat direction” of a passenger seat with a backrest and a seat part is to be understood as meaning, in particular, a horizontal direction relative to a transport means floor, which horizontal direction is aligned perpendicularly with respect to a backrest surface in an upright position of the passenger seat and points in the direction of the front edge of the seat part, the front edge of the seat part serving to support the lower part of the thighs and the knee region of a seated passenger. The seat direction can correspond to the transport direction of a transport means, in which the passenger seat device is mounted. In particular, if used in an aircraft cabin, the seat direction corresponds to the flight direction. If used in a railroad car, a tour bus or a passenger ship, the seat direction can be oriented counter to the transport direction. In the proposed configuration, all the passenger seats of the first and the second seat rows preferably have the same seat direction, the second seat row advantageously being arranged in front of the first seat row with regard to the seat direction. As a result, the rear side of the second seat row can advantageously be used to store a component of the comfort unit. Here, the expressions “in front of”, “behind”, “rear”, etc. relate to the common seat direction of the seat rows.

The comfort unit can have a surface element which forms the first supporting surface, is removed from the second seat row out of the storage position and is placed into the use position. However, a structurally simple embodiment and simple operation can be achieved if the comfort unit has at least one surface element which forms the first supporting surface and is mounted movably on the second seat row for a movement between the storage position and the use position. To this end, the second seat row has a bearing unit, by means of which the surface element is fixed on the second seat row and makes a movement of the surface element possible relative to the seat surface unit between the storage position and the use position. A “surface element” is to be understood, in particular, to be a component which is configured in a targeted manner for forming a supporting surface for supporting a body part of a passenger. In particular, the surface element is configured in such a way that, if, in the use position, the supporting surface which is formed preferably assumes a horizontal position relative to a transport means floor, said supporting surface has an extent in the seat direction, which extent is at least a quarter, in particular at least a third of the spacing in the seat direction between the second seat row and the front edge of the first seat row.

In the use position, the supporting surface which is formed by the surface element is preferably arranged in such a way that it is at a height relative to the transport means floor, which height substantially corresponds to the height of the seat surface unit of the first seat row, as a result of which comfortable lying can be achieved.

In order to achieve great comfort for a lying passenger, it is proposed that the first seat row has at least three passenger seats.

Furthermore, it is proposed that the comfort unit has a first surface element which forms the first supporting surface and at least one second surface element which forms a second supporting surface, as a result of which advantageous flexibility in the use of the comfort unit can be achieved.

In particular, the surface elements or the supporting surfaces of the comfort unit are assigned in each case to a different passenger seat of the first seat row, as a result of which a supporting surface of the comfort unit can be assigned to a defined seat surface of the first seat row.

In the use position, the supporting surface can be separated spatially from the seat surface unit of the first seat row, the supporting surface being spaced apart from the seat surface unit in the seat direction. This is suitable, in particular, if the supporting surface serves to support a lower body part of a passenger who is lying on the seat surface unit of the first seat row.

Great comfort and, in particular, a large lying surface area can be achieved if the comfort unit has at least one surface element which forms the first supporting surface and adjoins the first seat row in the use position. Here, in one advantageous development, the supporting surface of the comfort unit can form a preferably continuous extension of the seat surface unit in the seat direction of the first seat row.

In this context, a particularly large lying surface area can be achieved if the passenger seat device comprises a seat arrangement with the first seat row and a second seat row, the comfort unit having at least one surface element which forms the first supporting surface and connects the seat rows to one another in the use position. As a result, a spacing which exists between the seat rows can be used in an optimum manner for forming an enlarged lying surface area. In this embodiment, the surface element advantageously bridges the spacing in the seat direction between the front edge of a relevant seat part of a passenger seat of the first seat row and a backrest of the second seat row.

Furthermore, the comfort of a passenger can be increased further if the comfort unit has at least one surface element with an upholstery element which forms the first supporting surface.

Furthermore, compact storage of the comfort unit can be achieved if the passenger seat device comprises at least one backrest with a receiving region, the comfort unit having at least one surface element which forms the first supporting surface and is received in the receiving region in a storage position. The receiving region can be configured, in particular, as a depression in a rear side of the backrest, which rear side faces the first seat row. This is suitable, in particular, if the surface element is provided with an upholstery element and, on account of the latter, has an increased thickness. In one advantageous development of the invention, the passenger seat device has a bearing unit for movably mounting the surface element, which bearing unit is configured in such a way that the use position of the surface element is independent of an inclination of the backrest.

In a further refinement of the invention, it is proposed that the passenger seat device has a cover unit, the comfort unit having at least one surface element which forms the first supporting surface and forms at least one constituent part of the cover unit in a storage position. As a result, components and installation space can advantageously be saved. The cover unit is preferably assigned to a second seat row which is arranged directly in front of the first seat row with regard to the seat direction of the first seat row. It serves, in particular, for covering, preferably for covering the rear side of structural components of the second seat row, which structural components are arranged at the lower end of the second seat row, such as components of a load-bearing structure. In particular, as a result, said components can be protected against being struck by the feet of a passenger who is seated in the first seat row which is arranged behind said components.

Furthermore, increased use comfort of the passenger seat device can be achieved if the comfort unit has at least one surface element with at least one storage region which is provided to receive travel utensils in at least one position of the surface element, the surface element forming the first supporting surface.

Furthermore, it is proposed that the comfort unit has at least one surface element which forms the first supporting surface and forms a footrest surface in at least one position, which footrest surface is provided for resting feet of a passenger who is seated in a passenger seat, as a result of which the use of an additional footrest element can be dispensed with. Accordingly, the supporting surface of the surface element can optionally be used in a use position, preferably a horizontal use position relative to a transport means floor to support a body part of a passenger lying on the first seat row or in a preferably oblique use position relative to the transport means floor to rest the feet of a passenger who is situated in a normal seated position in an associated passenger seat of the first seat row.

### BRIEF DESCRIPTION OF THE DRAWINGS

Further advantages result from the following description of the drawing. Exemplary embodiments of the invention are shown in the drawing. The description and the claims contain numerous features in combination. A person skilled in the art will expediently also consider the features individually and combine them to form appropriate further combinations.

FIG. 1 is a perspective view of a seat arrangement from behind with two seat rows in the use position of a comfort unit,

FIG. 2 is the seat arrangement from FIG. 1 in a side view,

FIG. 3 is a surface element of the comfort unit with a storage compartment,

FIG. 4 is the seat arrangement with an alternative embodiment of the comfort unit, and

FIG. 5 is one of the seat rows with an alternative embodiment of the comfort unit as cover unit.

### DETAILED DESCRIPTION OF THE PREFERRED EMBODIMENTS

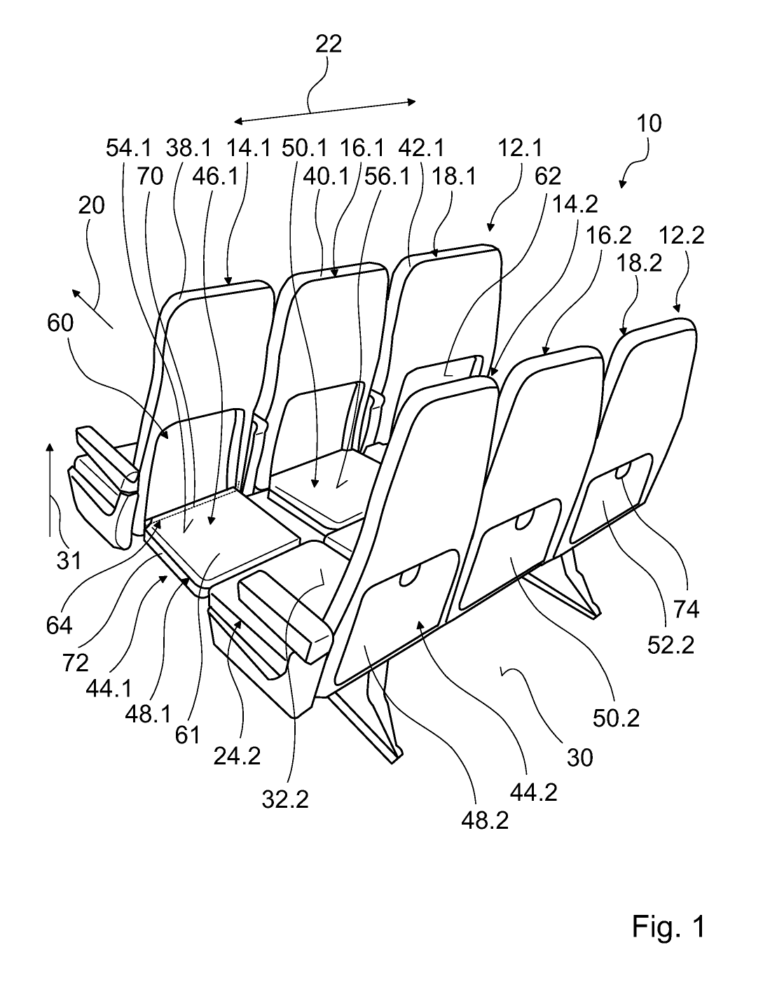

FIG. 1 shows a seat arrangement 10 with two seat rows 12.1, 12.2 which in each case have three passenger seats 14.1, 16.1, 18.1 and 14.2, 16.2, 18.2. The seat arrangement is arranged in an interior of a transport means (not shown) which moves in a transport direction in a normal mode. The transport direction corresponds to the seat direction 20 of the seat rows 12.1, 12.2. In the example being considered, the seat arrangement 10 is arranged in the cabin of an aircraft, the seat direction 20 corresponding to the flight direction. The seat arrangement which is described is also suitable for the equipping of tour buses, railroad cars, ferries, etc. In a seat row 12.1 or 12.2, the passenger seats 14, 16, 18 are arranged along a row direction 22 which is oriented perpendicularly with respect to the seat direction 20. The passenger seats 14, 16 and the passenger seats 16, 18 in a seat row 12.1 and 12.2, respectively, are directly adjacent with regard to the row direction 22. With regard to the seat direction 20, the seat rows 12.1, 12.2 are adjacent, said seat rows 12.1, 12.2 following one another directly in the seat direction 20 and the seat row 12.1 being arranged in front of the seat row 12.2. Here, the seat row 12.1 is also called “front” seat row 12.1 and the seat row 12.2 is also called “rear” seat row 12.2. Furthermore, the expressions “in front of”, “behind”, “in front”, “at the rear”, etc. relate to the seat direction 20. The seat rows 12.1 and 12.2 have the same seat direction 20 which corresponds to the transport direction. In one alternative design variant, such as in the case of a use in a railroad car, for example, the seat direction 20 of the seat rows 12.1, 12.2 can be oriented counter to the transport direction. The seat arrangement is erected on a floor 30, a vertical direction 31 being defined which is oriented perpendicularly with respect to the floor 30.

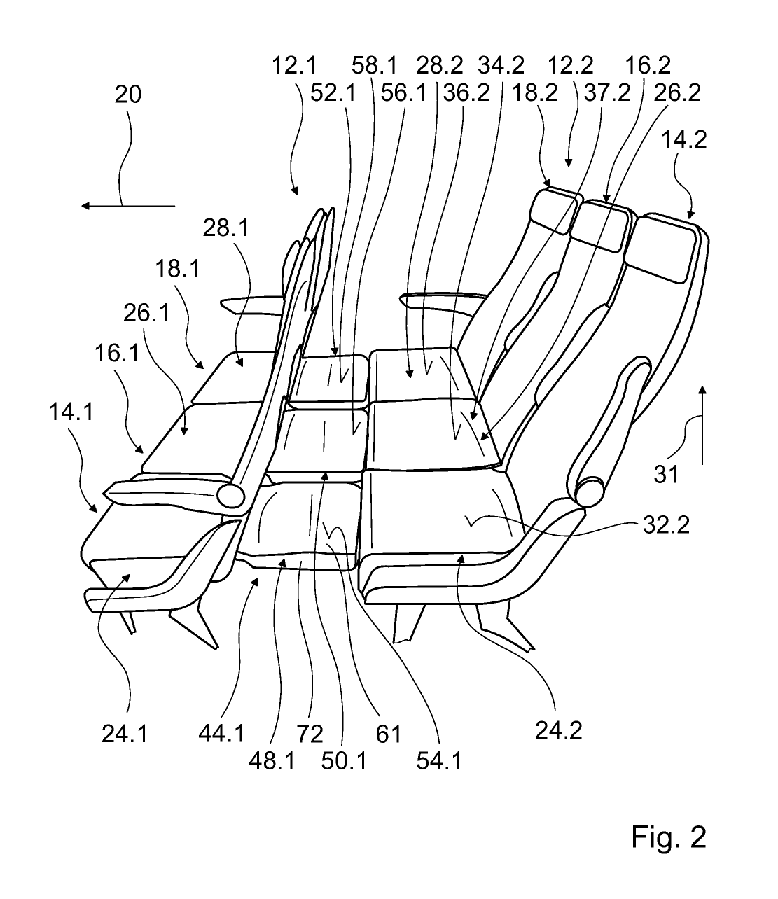

The following description likewise relates to FIG. 2, in which the seat rows 12.1, 12.2 are shown in a side view.

The passenger seats 14.2, 16.2, 18.2 in each case have a seat part 24.2, 26.2 and 28.2, respectively, which is erected on the floor 30 in a known way. The seat parts 24.2, 26.2, 28.2 in each case form a seat surface 32.2, 34.2 and 36.2, respectively, by means of an upholstery unit. In other words, the seat surfaces 32.2, 34.2, 36.2 in the seat row 12.2 are in each case assigned to a different passenger seat 14.2, 16.2 and 18.2, respectively. The seat surfaces 32.2, 34.2, 36.2 which are separated from one another form a seat surface unit 37.2 which is accordingly assigned to the entire seat row 12.2 with the passenger seats 14.2, 16.2, 18.2. In one alternative design variant, the seat surface unit 37.2 can be formed by a single, contiguous seat surface which extends over the length of the seat row 12.2 in the row direction 22. Furthermore, the passenger seats 14.1, 16.1, 18.1 in each case have a backrest 38.1, 40.1, 42.1.

The seat row 12.2 can be occupied conventionally by three seated passengers. It can be booked by a single passenger in the case of long haul journeys, in particular in the case of overnight journeys, which passenger occupies all the passenger seats 14.2, 16.2, 18.2 of the seat row 12.2 for lying. Here, the seat surface unit 37.2 can be used by a passenger for lying in a lying position in the row direction 22. In order to increase the comfort of the passenger, a comfort unit 44.1 is provided which serves to enlarge the lying surface area which is made available by the seat surface unit 37.2 of the seat row 12.2. In a use position which is shown in FIGS. 1 and 2, the comfort unit 44.1 provides an additional surface unit 46.1 which, in combination with the seat surface unit 37.2, forms a lying surface area for the passenger to lie on, which lying surface area is enlarged in comparison with the lying surface area which is formed by the seat surfaces 32.2, 34.2, 36.2.

The comfort unit 44.1 has a set of a plurality of surface elements 48.1, 50.1, 52.1 which are assigned in each case to a different passenger seat 14.1, 16.1, 18.1. They in each case form a supporting surface 54.1, 56.1, 58.1 which forms a part of the additional surface unit 46.1. The supporting surfaces 54.1, 56.1, 58.1 in each case correspond to an additional surface which the passenger who is lying on the seat surface unit 37.2 can use to support one of his body parts. Thus, for example, the supporting surface 54.1 of the comfort unit 44.1 can be used to support the feet of the passenger when the head of the passenger lies on the seat surface 36.2 in a lying position. Further lying positions are likewise possible by, for example, the head of the passenger lying on the supporting surface 58.1 of the comfort unit 44.1, while his feet are supported on the seat surface 32.2.

In the use position, the supporting surfaces 54.1, 56.1, 58.1 are oriented horizontally relative to the floor 30 and point upward relative to the vertical direction 31. Relative to the floor 30, they are at the same height as the seat surface unit 37.2.

The surface elements 48.1, 50.1, 52.1 are in each case assigned to a different passenger seat 14.2, 16.2 and 18.2, respectively, of the rear seat row 12.2. Here, they are arranged opposite an associated seat part 24.2, 26.2 and 28.2, respectively, in relation to the seat direction 20. As a result, the surface elements 48.1, 50.1, 52.1 and accordingly the supporting surfaces 54.1, 56.1, 58.1 are assigned in each case to a seat surface 32.2, 34.2 and 36.2, respectively. In the exemplary embodiment under consideration, the surface elements 48.1, 50.1, 52.1 adjoin, in particular with their rear edge, the rear seat row 12.2, to be precise, in particular, the front edge of the rear seat row 12.2 or of the associated seat part 24.2, 26.2, 28.2. Accordingly, the supporting surfaces 54.1, 56.1 and 58.1 can form a preferably continuous extension of the seat surface 32.2, 34.2 and 36.2, respectively, to the front in the seat direction 20.

Starting from the use position which is shown in FIGS. 1 and 2, the comfort unit 44.1 can be moved into a storage position which is suitable for a conventional use of the seat row 12.2 for seating a plurality of passengers. With regard to the storage position, the comfort unit 44.1 is assigned to the front seat row 12.1. Here, the surface elements 48.1, 50.1, 52.1 are received in their respective storage position in receiving regions 60 of the front seat row 12.1. The receiving regions 60 correspond in each case to a depression which is cut out in a backrest 38.1, 40.1 and 42.1 of the front seat row 12.1. In the storage position, the respective surface element 48.1, 50.1, 52.1 bears against a rear wall 62 of the receiving region 60 with an upholstery element 61 which forms the supporting surface 54.1, 56.1 and 58.1, respectively. In FIG. 1, the storage position can be seen on the rear side of the passenger seats 14.2, 16.2, 18.2 which are configured identically to the passenger seats 14.1, 16.1, 18.1 and likewise have surface elements 48.2, 50.2, 52.2 of a comfort unit 44.2 which is assigned to the rear seat row 12.1, which surface elements are provided for interaction with seat surfaces of a seat row (not shown) which is arranged behind the seat row 12.2. In FIG. 1, the surface elements 48.2, 50.2, 52.2 are shown in their storage position in each case in a receiving region 60.

Furthermore, the surface elements 48.1, 50.1, 52.1 are mounted movably in each case on the corresponding passenger seat 14.1, 16.1, 18.1 of the front seat row 12.1. Here, the surface elements 48.1, 50.1, 52.1 are mounted movably in each case by means of a bearing unit 64 on the backrest 38.1, 40.1 and 42.1, respectively, of the corresponding passenger seat 14.1, 16.1 and 18.1, respectively. In the exemplary embodiment under consideration, a surface element 48.1, 50.1 and 52.1 can be moved from the storage position, in which it abuts the corresponding backrest 38.1, 40.1 and 42.1, respectively, until, when it reaches the use position, it adjoins the associated seat part 24.2, 26.2 and 28.2, respectively, to be precise a front edge of the associated seat part 24.2, 26.2 and 28.2, respectively. A locking means (not shown), by means of which the surface element 48.1, 50.1 and 52.1 is locked in the use position, can be attached to the corresponding backrest 38.1, 40.1 and 42.1, respectively, and/or to the seat part 24.2, 26.2 and 28.2, respectively, which is assigned to the surface element 48.1, 50.1 and 52.1, respectively.

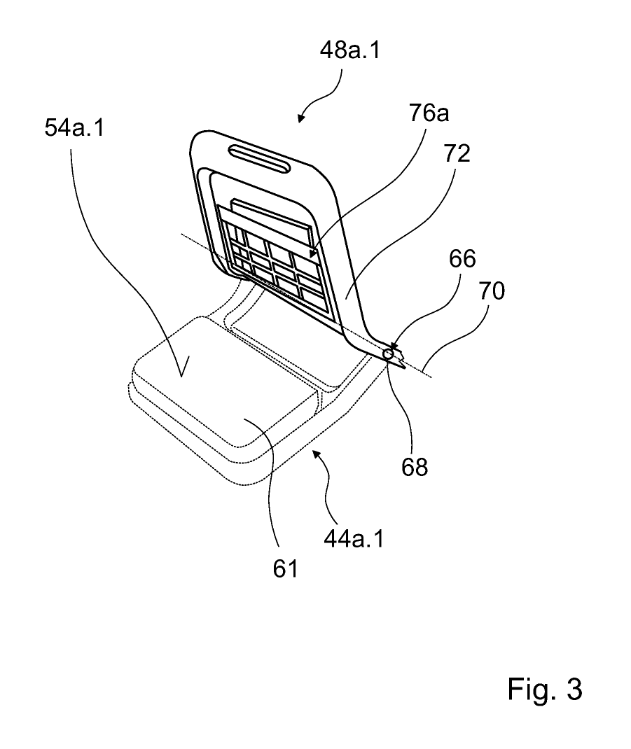

The respective bearing units 64 have a pivoting apparatus 66 which is shown in FIG. 3 and by means of which the corresponding surface element 48.1, 50.1 and 52.1 can be pivoted or folded down between the storage position and the use position. For example, the pivoting apparatus 66 has a pivot axis unit 68 (see FIG. 3) which fixes a pivot axis of the pivoting movement of the surface element 48.1, 50.1 and 52.1. The pivot axis 70 is oriented horizontally relative to the floor 30 and perpendicularly with respect to the seat direction 20. The surface elements 48.1, 50.1, 52.1 in each case have a basic body 72 which is fixed pivotably on the corresponding backrest 38.1, 40.1, 42.1 by means of the bearing unit 64. In the storage position of a surface element 48.1, 50.1, 52.1 and with regard to the vertical direction 31, the pivot axis 70 is arranged in the lower end region of the basic body 72. The upholstery element 61 which forms the supporting surface 54.1, 56.1 and 58.1 in the use position is fixed on the basic body 72. In the storage position, the upholstery element 61 bears against the rear wall 62 of the corresponding receiving region 60 of the respective backrest 38.1, 40.1 and 42.1.

As a result of the direct mounting of the surface elements 48.1, 50.1, 52.1 on the associated backrests 38.1, 40.1, 42.1 of the front seat row 12.1 and as a result of the fact that, in the use position, the surface elements 48.1, 50.1, 52.1 adjoin the associated seat part 24.2, 26.2, 28.2, the surface elements 48.1, 50.1, 52.1 connect the rear seat row 12.2 to the front seat row 12.1 in the use position, as a result of which a spacing between the seat rows 12.1 and 12.2 and the spacing between the front edge of a seat part 24.2, 26.2, 28.2 and the backrest 38.1, 40.1 and 42.1, respectively, of the passenger seat 14.1, 16.1 and 18.1, respectively, which is arranged directly in front in the seat direction 20 are bridged.

For the simple handling of the surface elements 48, 50, 52 of the comfort units 44.1, 44.2, a grip means 74 is arranged in each case on that rear side of the surface elements 48.1, 50.1, 52.1 which faces the floor 30 in the use position, which grip means 74 is provided for being gripped by an operator, in order to move the corresponding surface element 48, 50 and 52 from the storage position into the use position.

FIG. 3 shows an alternative embodiment of a surface element 48a.1 of a comfort unit 44a.1, which can be used for an application in the seat arrangement 10 from FIGS. 1 and 2. In order to avoid unnecessary repetitions, the following description is directed substantially at the differences to the above-described surface elements 48.1, 50.1, 52.1. Reference is made to the above description with regard to features which are not described. Components which have a construction and/or a function which are/is identical to the above exemplary embodiment are denoted by the same designation, optionally with the addition of the additional letter “a”.

The surface element 48a.1 is shown in its storage position and in its use position (dashed lines). The pivoting apparatus 66 with the pivot axis unit 68 serves for a transition between the storage position and the use position and is provided for pivotable mounting of the surface element 48a.1 or of its basic body 72 on a backrest 38, 40 or 42 about the pivot axis 70. The upholstery element 61 which forms a supporting surface 54a.1 is fastened to the basic body 72. The rear side of the surface element 48a.1, which rear side faces the floor 30 in the use position and faces a rear seat row in the storage position, has a storage region 76a in the form of a storage compartment, which storage region 76a, at least in the storage position of the surface element 48a.1, is provided for receiving travel utensils, such as magazines, safety warnings or personal travel articles of a passenger.

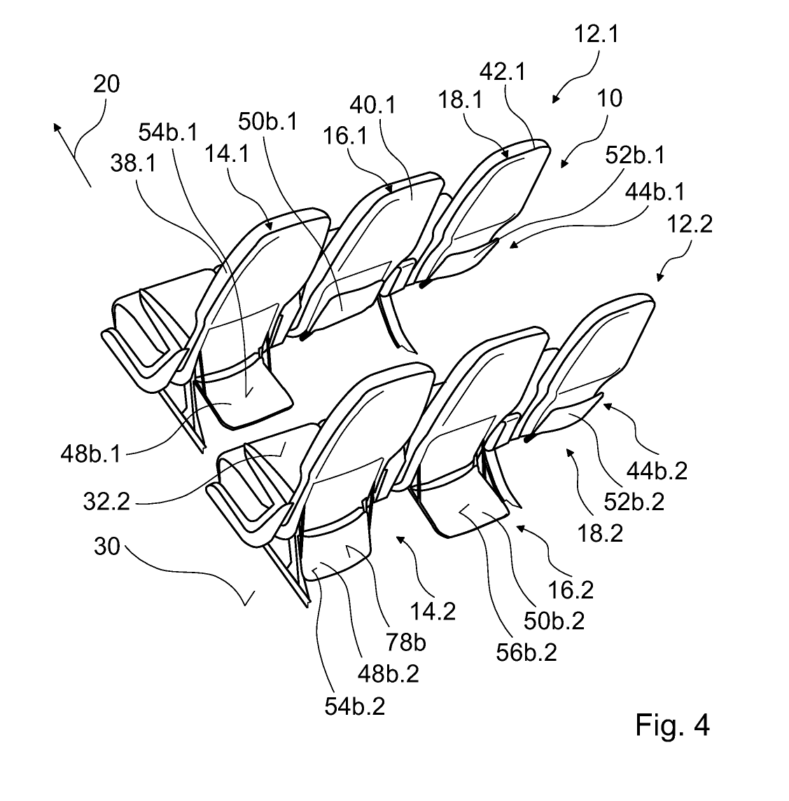

FIG. 4 shows an alternative embodiment of the seat arrangement 10. The following description is directed substantially at the differences from the seat arrangement 10 which is described using FIGS. 1 and 2. Reference is made to the above description with regard to features which are not described. Components which have a construction and/or a function which are/is identical to the above exemplary embodiment are denoted by the same designation, optionally with the addition of the additional letter “b”.

In the embodiment of FIG. 4, the seat arrangement 10 has a comfort unit 44b.1 which is assigned to the front seat row 12.1 and a comfort unit 44b.2 which is assigned to the rear seat row 12.2. The following description is restricted to the comfort unit 44b.1, the comfort unit 44b.2 being of identical configuration. The comfort unit 44b.1 has surface elements 48b.1, 50b.1, 52b.1 which are assigned in each case to a different passenger seat 14.2, 16.2 and 18.2, respectively, of the rear seat row 12.2. The surface elements 48b.1, 50b.1, 52b.1 have a storage position, in which they are oriented substantially in the vertical direction 31 and have a free end which is arranged in the region of the rear side of the corresponding backrest 38.1, 40.1 and 42.1, respectively, of the front seat row 12.1. FIG. 4 shows the surface elements 50b.1, 52b.1 and 52b.2 in the storage position. Starting from this storage position, the surface elements can be folded down, to be precise into a first use position, in which they form a supporting surface which is oriented substantially horizontally and is at a height relative to the floor 30 which corresponds to the height of an associated seat surface 32, 34 and 36 of a seat row 12 which is arranged directly behind. FIG. 4 shows the surface elements 48b.1 and 50b.2 in the first use position. In this use position, supporting surfaces are formed which are denoted in the figure by the designations 54b.1 and 56b.2 and serve to support a body part of a passenger who is lying on a corresponding seat surface unit 37. For example, a lying passenger of the seat row 12.2 can support his feet on the supporting surface 54b.1, while a passenger lying on his side of a seat row (not shown) which is arranged behind the seat row 12.2 can use the supporting surface 56b.2 to support his knees.

In the exemplary embodiment under consideration, a surface element of the front seat row 12.1, to be precise in particular the surface element 48b.1 in the first use position is spaced apart from the rear seat row 12.2 in the seat direction 20. As a result, in comparison with the design variant from FIGS. 1 and 2, weight can be saved during the production of the surface elements 48b.1, 50b.1, 52b.1 and installation space can be saved for storing the latter in the storage position.

Starting from the first use position, the surface elements 48b, 50b, 52b can be pivoted further downward into a second use position, in which they form a footrest surface 78b, on which a passenger who is seated in a rear passenger seat can rest his feet. FIG. 4 shows the surface element 48b.2 in the second use position. In this use position, the footrest surface 78b is arranged obliquely relative to the floor 30, that is to say it forms an angle with a horizontal plane relative to the floor 30.

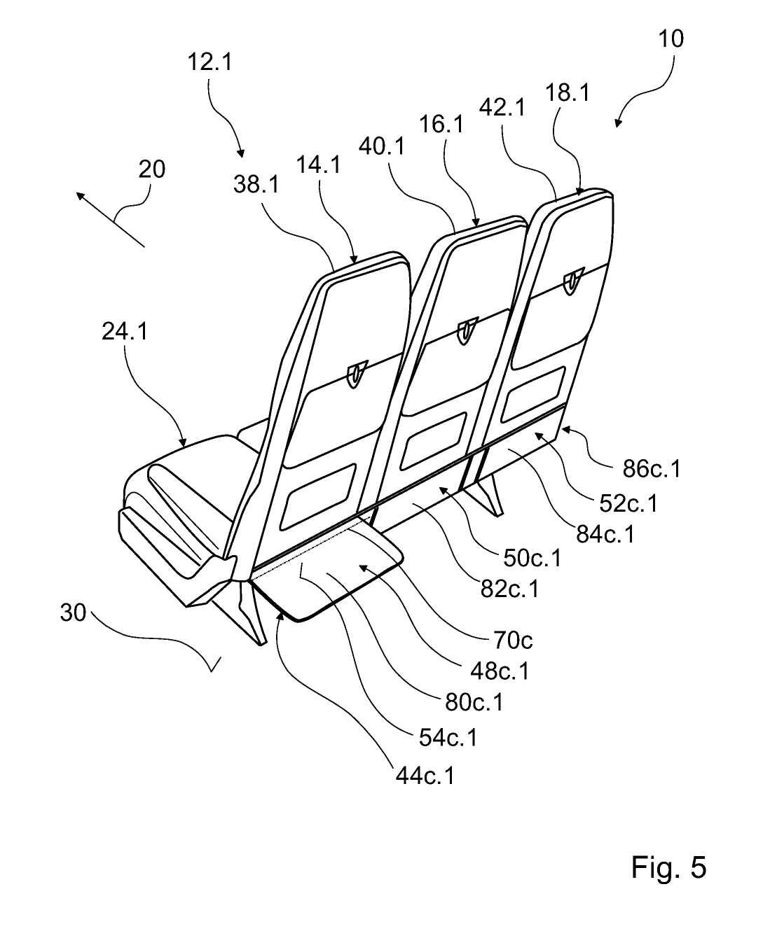

FIG. 5 shows a further embodiment of the seat arrangement 10. The following description is directed substantially at the differences from the seat arrangement 10 which is described using FIGS. 1 and 2. Reference is made to the above description with regard to features which are not described. Components which have a construction and/or a function which are/is identical to the above exemplary embodiment are denoted by the same designation, optionally with the addition of the additional letter “c”.

FIG. 5 and the following description are restricted to the front seat row 12.1, the rear seat row 12.2 being configured identically to the front seat row 12.1. The passenger seats 14.1, 16.1, 18.1 in each case have a cover element 80c.1, 82c.1 and 84c.1, respectively, which is arranged at the lower end of the corresponding backrest 38.1, 40.1, 42.1. The cover elements 80c.1, 82c.1, 84c.1 serve to cover a stand structure of the corresponding passenger seat 14.1, 16.1 and 18.1, respectively, by means of which the seat parts 24.1, 26.1, 28.1 are erected on the floor 30 and which can be configured, for example, as a load-bearing tubular unit. The cover elements 80c.1, 82c.1, 84c.1 are constituent parts of a cover unit 86c.1 which extends over the entire seat row 12.1. In the relevant expert vocabulary, the cover unit 86c.1 is also called a “kick panel”. The cover unit 86c.1 is arranged in the foot region of the seat row 12.1 and serves, in particular, to avoid the feet of a passenger who is seated in the rear seat row 12.2 striking the stand structure of the front seat row 12.1 and/or to absorb or dissipate in a targeted manner forces of this strike.

The cover elements 80c.1, 82c.1, 84c.1 likewise serve as surface elements 48c.1, 50c.1 and 52c.1, respectively, of a comfort unit 44c.1. To this end, the cover elements 80c.1, 82c.1, 84c.1 are mounted movably on the corresponding passenger seat 14.1, 16.1 and 18.1, respectively, to be precise by means of a pivoting apparatus which forms a horizontal pivot axis 70c. Starting from a position, in which it is folded onto the passenger seat and which corresponds to the storage position of the surface elements 48c.1, 50c.1 and 52c.1 and in which they have a covering function, the surface elements 48c.1, 50c.1 and 52c.1 and the cover elements 80c.1, 82c.1, 84c.1 can be pivoted upward into a horizontal position which corresponds to the use position of the comfort unit 44c. In FIG. 5, the cover element 80c.1 is arranged in the horizontal position, said cover element 80c.1 serving as a surface element 48c.1 which forms a horizontal supporting surface 54c.1. The latter is at a height relative to the floor 30, which height corresponds substantially to the height of the associated seat surface 32.2 of the rear seat row 12.2. Here, as has already been described above, the supporting surface 54c.1 can be used to support a body part of a passenger lying on the seat row 12.2.

1. A passenger seat device having a seat surface unit which is assigned to a first seat row with a plurality of passenger seats characterized by comprising:
a comfort unit which, in addition to the seat surface unit forms at least one first supporting surface in at least one use position, the at least one first supporting surface is provided for supporting at least one body part of a lying passenger.

2. The passenger seat device as claimed in claim 1, further comprising:
a seat arrangement with the first seat row and a second seat row, the comfort unit being assigned at least to the second seat row in a storage position.

3. The passenger seat device as claimed in claim 2, wherein the comfort unit has at least one surface element which forms the first supporting surface and is mounted movably on the second seat row for a movement between the storage position and the use position.

4. The passenger seat device as claimed in claim 1, wherein the first seat row has at least three passenger seats.

5. The passenger seat device as claimed in claim 1, wherein the comfort unit has a first surface element which forms the first supporting surface and at least one second surface element which forms a second supporting surface.

6. The passenger seat device as claimed in claim 5, wherein the surface elements are assigned in each case to a different passenger seat of the first seat row.

7. The passenger seat device as claimed in claim 1, wherein the comfort unit has at least one surface element which forms the first supporting surface and adjoins the first seat row in the use position.

8. The passenger seat device as claimed in claim 7, further comprising:
a seat arrangement with the first seat row and a second seat row, the comfort unit having at least one surface element which forms the first supporting surface and connects the seat rows to one another in the use position.

9. The passenger seat device as claimed in claim 1, wherein the comfort unit has at least one surface element with an upholstery element which forms the first supporting surface.

10. The passenger seat device as claimed in claim 1, further comprising:
at least one backrest with a receiving region, the comfort unit having at least one surface element which forms the first supporting surface and is received in the receiving region in a storage position.

11. The passenger seat device as claimed in claim 1, characterized by further comprising:
a cover unit, the comfort unit having at least one surface element which forms the first supporting surface and forms at least one constituent part of the cover unit in a storage position.

12. The passenger seat device as claimed in claim 1, wherein the comfort unit has at least one surface element with at least one storage region which is provided to receive travel utensils in at least one position of the surface element, the surface element forming the first supporting surface.

13. The passenger seat device as claimed in claim 1, wherein the comfort unit has at least one surface element which forms the first supporting surface and forms a footrest surface in at least one position, which footrest surface is provided for resting feet of a passenger who is seated in a passenger seat.

14. The passenger seat device as claimed in claim 2, wherein the first seat row has at least three passenger seats.

15. The passenger seat device as claimed in claim 2, wherein the comfort unit has a first surface element which forms the first supporting surface and at least one second surface element which forms a second supporting surface.

16. The passenger seat device as claimed in claim 15, wherein the surface elements are assigned in each case to a different passenger seat of the first seat row.

17. The passenger seat device as claimed in claim 2, wherein the comfort unit has at least one surface element which forms the first supporting surface and adjoins the first seat row in the use position.

18. The passenger seat device as claimed in claim 17, further comprising:
a seat arrangement with the first seat row and a second seat row, the comfort unit having at least one surface element which forms the first supporting surface and connects the seat rows to one another in the use position.

19. The passenger seat device as claimed in claim 2, wherein the comfort unit has at least one surface element with an upholstery element which forms the first supporting surface.

20. The passenger seat device as claimed in claim 2, further comprising:
at least one backrest with a receiving region, the comfort unit having at least one surface element which forms the first supporting surface and is received in the receiving region in a storage position.
